(19) United States
(12) Patent Application Publication
(10) Pub. No.: US 2020/0082804 A1
(43) Pub. Date: Mar. 12, 2020

(54) Event Triggering in Phased-Array Systems

(71) Applicant: ULTRAHAPTICS IP LTD, Bristol (GB)

(72) Inventors: Brian Kappus, Mountain View, CA (US); Benjaimin John Oliver Long, Bristol (GB)

(21) Appl. No.: 16/564,016

(22) Filed: Sep. 9, 2019

Related U.S. Application Data
(60) Provisional application No. 62/728,830, filed on Sep. 9, 2018.

(51) Int. Cl. G10K 11/34

(52) U.S. Cl. CPC G10K 11/34

(57) ABSTRACT

Creating near-instantaneous effects in a phased-array system may occur by splitting the update process of the array state into parts that depend on different update rates. Alternatively, leveraging the uncertainty of physical properties of focusing in a phased-array system may improve the intersection between the body part and the control point. Specifically, by focusing behind or in front of the intended region or at a position with a calculated geometric relationship to the intended interaction region, a larger volume (region) of space is addressed that more certainly contains the body part participating in the interaction. This larger volume is then subjected to the ultrasonic radiative energy flux that encodes the properties desired for the interaction point, which may include haptic and/or audio points.

### RELATED APPLICATION

This application claims the benefit of the following U.S. Provisional Patent Applications, which is incorporated by reference in its entirety:

1) Ser. No. 62/728,830, filed on Sep. 9, 2018.

### FIELD OF THE DISCLOSURE

The present disclosure relates generally to improved techniques for using timing techniques to improve performance of phased-array systems.

### BACKGROUND

A continuous distribution of sound energy, which will be referred to as an “acoustic field”, can be used for a range of applications including parametric audio, haptic feedback in mid-air and the levitation of objects.

By defining one or more control points in space, the acoustic field can be controlled. Each point can be assigned a value equating to a desired amplitude at the control point. A physical set of transducers can then be controlled as a phased-array system to create an acoustic field exhibiting the desired amplitude at the control points.

To create specific dynamic acoustic fields, information about timing is important, as different transducers must be supplied waves that are precisely synchronized in time. If the field is to be dynamically controlled in a way that deviates from the traditional approach of assuming a static field for all time, then the device must be aware of the time of flight necessary to effect a change in the field such that waves from each transducer reach the same point at the same time. This allows the device to create near-instantaneous changes (within a few periods of the carrier frequency) in the field. However, the computational requirements of driving the array calculations at a speed necessary to respond quickly enough to include near-instantaneous effects is prohibitive. If there were a way to include these effects without the computational cost, then this would be commercially valuable.

Further, for many applications, including parametric audio and haptic feedback in mid-air, it is necessary to modulate the acoustic field at the control points through time. This is achieved by modulating the values assigned to each point, changing these to produce one or more waveforms at the given control points. Without loss of generality, techniques demonstrated on a monochromatic field may be extended to these fields that contain time-dependent modulated signal waveforms.

By modulating these with waveforms including components in the ranges of frequencies (0-500 Hz) that may be perceived by the skin, haptic feedback may be created. These points of haptic feedback are the control points, which are created by controlling a substantially monochromatic ultrasonic acoustic field to generate this known excitation waveform at a point in space. When an appropriate body part intersects this point in the air, the acoustic field is demodulated into either a haptic sensation experienced by the skin or an audible sound that may be experienced.

Tracking systems are required to determine the location and orientation of body parts to determine where to place the control points to best elicit the haptic or audio desired. These tracking systems may be poorly calibrated or insufficiently precise, creating potentially large sources of error in the locations of the creation of these points.

### SUMMARY

One method to create near-instantaneous effects as described above is to split the update process of the array state into parts that depend on different update rates. Alternatively, leveraging the physical properties of the focusing system may improve the intersection between the body part and the control point in the presence of uncertainty in the tracking system. Specifically, by focusing behind or in front of the intended region or at a position with a calculated geometric relationship to the intended interaction region, a larger volume (region) of space is addressed which more certainly contains the body part participating in the interaction. This larger volume is then subjected to the ultrasonic radiative energy flux which encodes the properties desired for the interaction point, which may include haptic and/or audio points.

### BRIEF DESCRIPTION OF THE DRAWINGS

The accompanying figures, where like reference numerals refer to identical or functionally similar elements throughout the separate views, together with the detailed description below, are incorporated in and form part of the specification, serve to further illustrate embodiments of concepts that include the claimed invention and explain various principles and advantages of those embodiments.

FIGS. 1, 2, 3, 4, 5 and 6 are exemplary wave radiation schematics generated by a plurality of transducers.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

I. Adding Timed Triggers

A way to create near-instantaneous effects as described above, is to split the update process of the array state into parts that depend on different update rates. Using this approach, the slow updates that contain individual transducer or array state data that occupy the array for a given period of time are updated through one channel, but discrete ‘triggering’ commands or events that occur or are applied instantly are updated through another. These triggering commands may be time-stamped with the time at which they are intended to be applied and priority queued on the device in a location specifically to quickly determine the next command and apply it. If they refer to a process that occurs in the acoustic field, they may also be applied in a staggered fashion to each transducer so that the effects generated by the command reach the control point simultaneously at the instant in time specified in the time-stamp. Given that these commands are time-stamped, they may be sent to multiple devices in turn and these devices may be guaranteed to wait the appropriate amount of time before triggering the effect. Examples of such commands include but are not limited to: instantaneous change of the transducer driving signal to some preloaded state, powering the device off or down, inducing a specified phase shift at the control point, triggering an external device by driving an edge on an output pin, triggering the generation of instantaneous debugging information or responding to invalid input.

Additionally, the timing of the triggers for these commands may be offset by the time of flight required for the waves to travel and reach the point where the desired effect is to be created. Especially in the context of haptics and parametric audio, this enables the timestamp of these timed commands to be coincident with the onset of a sensory cue. Optionally, this yields synchronization of the cue to the user with an external device. Alternatively, this offset may be used ahead of time, allowing a change in the device to be specified with a known timestamp such that it is guaranteed for the waves to reach a target point at this known time. This may elicit a synchronized sensory experience linked to an external event.

In the inverse case, the device may use time stamping to signify that events have occurred. Examples of such events that could trigger include but are not limited to: microphones recording a test signal, component failure or obtaining some processed information through microphones or other input.

II. Optical Lens Modeling and Analysis

The areas filled with acoustic radiation energy when the transducer array is focused can be visualized analogously to an optical lens. The array when operating is an ‘aperture’ which is synthesized from the contributions from each of the transducers, this is projected through the focus when the phased array system is actively focusing. Intuitively and roughly speaking therefore, at twice the focusing distance the energy flux that was focused is now spread over an area equivalent to the array size.

The concentration and subsequent rarefaction of the energy flux along the focusing path may be leveraged to provide a larger volume for the energy to flow through. Choosing a different part of the beam to use away from the focus is effectively equivalent to a larger focal spot. These regions of high energy are effectively also phase-coherent, preventing ringing due to phase inversions that could cause inconsistencies.

The direction of energy flux in the field at any point is given by the wave vector. This can be derived through a solution to the wave equation for a given field. Another way to determine this vector is to perform a weighted sum of wave vectors from each individual transducer. If the transducer can be considered a point source, which occurs in most of the field for most mid-air haptic arrangements, the wave vector is in the direction of a line connecting the center of the transducer to the point of interest (such as a focus point). Alternatively, the magnitude and direction of wave vectors for each transducer can be calculated through a simulation or measurement. These vectors are weighted by the transducer emission amplitude during summation.

For a planar array with a relatively constant density of transducers and relatively even drive amplitude, a further simplification can be made by drawing a line from the geometric center of the array to the focus point. This will form the direction of the wave vector in that case.

A plane defined with the wave vector as its normal will contain pressure profiles important to this invention. A line drawn in this plane through the pressure peak defines an acoustic pressure amplitude versus distance cross-section. This cross-section can then define metrics such as ‘size’ through full-width-half-max (FWHM), length above a threshold value, or some other evaluation of this curve. For some fields, it can be converging along one cross section and diverging along another.

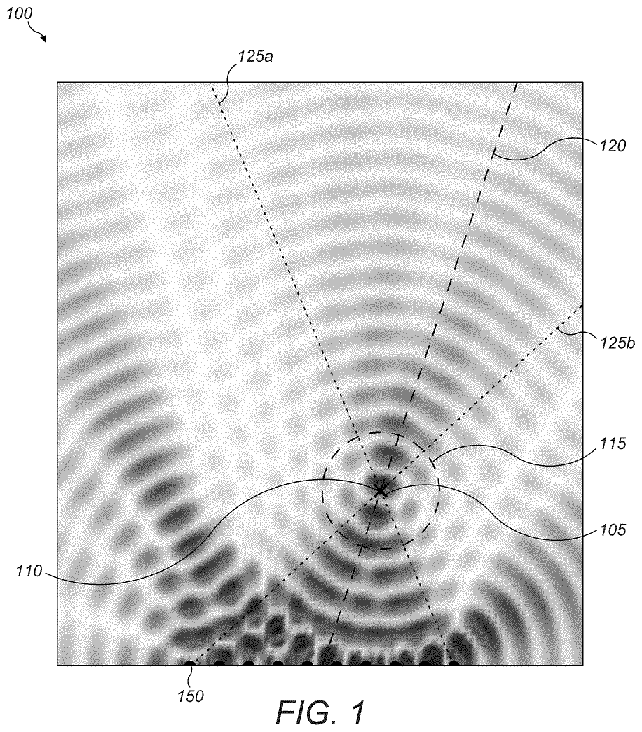

In an exemplary wave radiation schematic 100 in FIG. 1, the center of desired consistent wave radiation is shown with a cross 105 and its circular extent is denoted by a dashed circle 115. Dotted lines 125a, 125b show the array aperture projected through the control point and their geometric relationship to the desired region. The focus specified is marked with a small dot 110 and the centerline through the focus is a dashed line 120. In this FIG. 1, the small dot 110 generally occupies the same space as the cross 105. The transducers 150 are point sources in this example and are shown as solid semi-circular protrusions at the lower edge of each image. Specifically, FIG. 1 shows focusing directly at a point in the center of a desired region often creates phase inversions and large variations in amplitude due to diffraction and the concentration of energy involved.

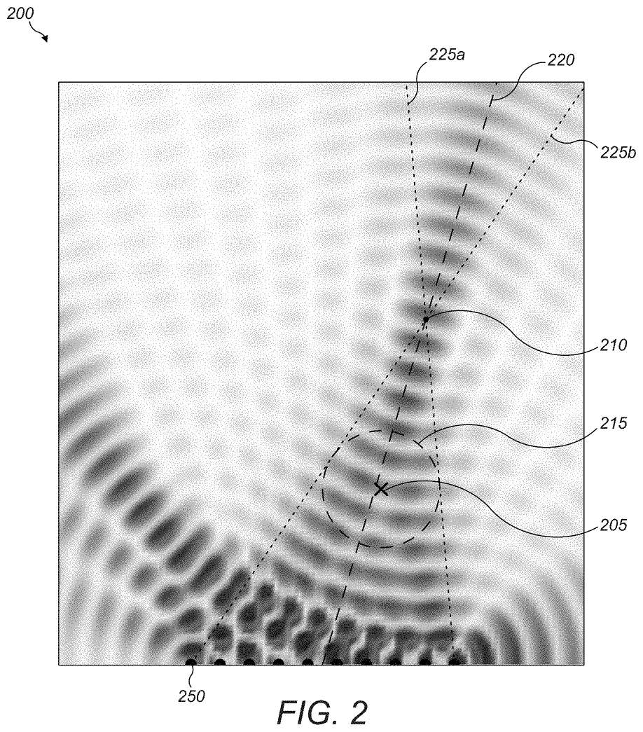

In an exemplary wave radiation schematic 200 in FIG. 2, the center of desired consistent wave radiation is shown with a cross 205 and its circular extent is denoted by a dashed circle 215. Dotted lines 225a, 225b show the array aperture projected through the control point and their geometric relationship to the desired region. The focus specified is marked with a small dot 210 and the centerline through the focus is a dashed line 220. The transducers 250 are point sources in this example and are shown as solid semi-circular protrusions at the lower edge of each image. Specifically, FIG. 2 shows creating the region in the near field to encapsulate the large region.

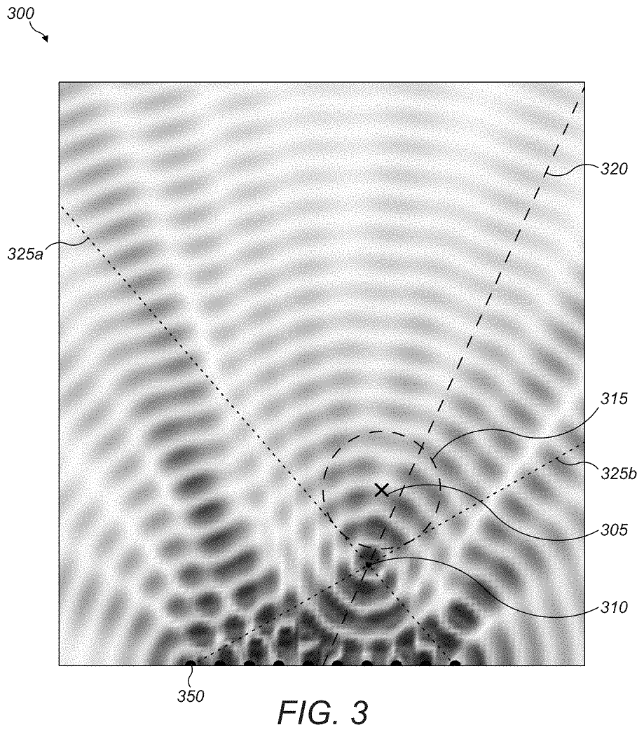

In an exemplary wave radiation schematic 300 in FIG. 3, the center of desired consistent wave radiation is shown with a cross 305 and its circular extent is denoted by a dashed circle 315. Dotted lines 325a, 325b show the array aperture projected through the control point and their geometric relationship to the desired region. The focus specified is marked with a small dot 310 and the centerline through the focus is a dashed line 320. The transducers 350 are point sources in this example and are shown as solid semi-circular protrusions at the lower edge of each image. Specifically, FIG. 3 shows creating the region in the far field to encapsulate the desired region.

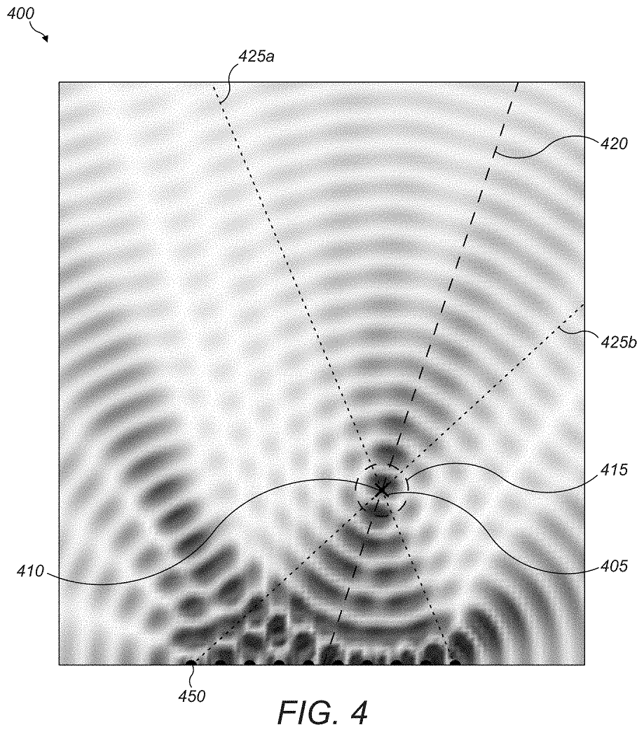

In an exemplary wave radiation schematic 400 in FIG. 4, the center of desired consistent wave radiation is shown with a cross 405 and its circular extent is denoted by a dashed circle 415. Dotted lines 425a, 425b show the array aperture projected through the control point and their geometric relationship to the desired region. The focus specified is marked with a small dot 410 and the centerline through the focus is a dashed line 420. In this FIG. 4, the small dot 410 generally occupies the same space as the cross 405. The transducers 450 are point sources in this example and are shown as solid semi-circular protrusions at the lower edge of each image. Specifically, FIG. 4 shows a smaller region that may be used which drops sharply in amplitude towards the edges of the region.

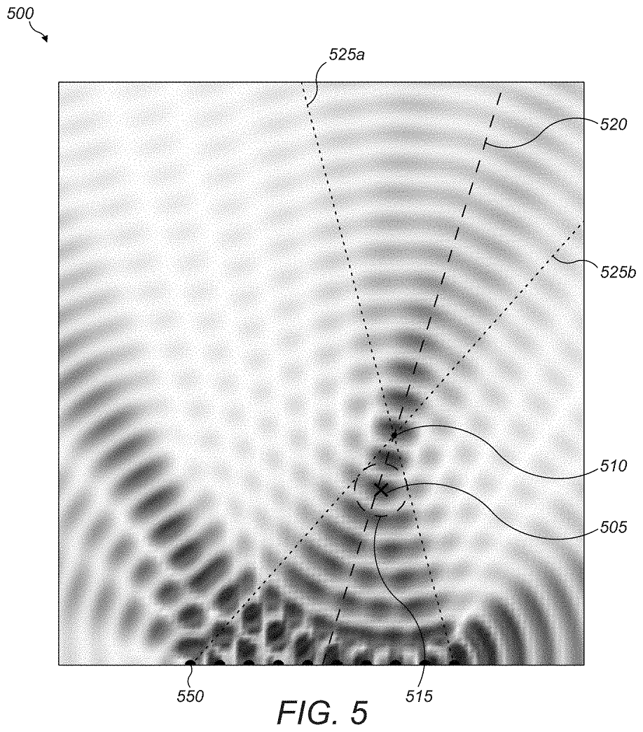

In an exemplary wave radiation schematic 500 in FIG. 5, the center of desired consistent wave radiation is shown with a cross 505 and its circular extent is denoted by a dashed circle 515. Dotted lines 525a, 525b show the array aperture projected through the control point and their geometric relationship to the desired region. The focus specified is marked with a small dot 510 and the centerline through the focus is a dashed line 520. The transducers 550 are point sources in this example and are shown as solid semi-circular protrusions at the lower edge of each image. Specifically, FIG. 5 shows for small regions, the focusing is not changed enormously and can be smoothly modified over time if a region grows or shrinks contiguously.

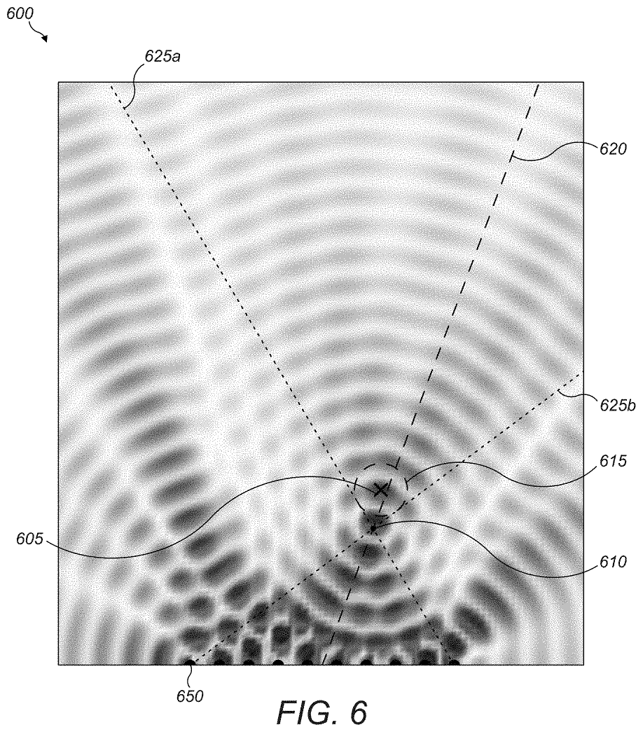

In an exemplary wave radiation schematic 600 in FIG. 6, the center of desired consistent wave radiation is shown with a cross 605 and its circular extent is denoted by a dashed circle 615. Dotted lines 625a, 625b show the array aperture projected through the control point and their geometric relationship to the desired region. The focus specified is marked with a small dot 610 and the centerline through the focus is a dashed line 620. The transducers 650 are point sources in this example and are shown as solid semi-circular protrusions at the lower edge of each image. Specifically, FIG. 6 shows a smaller far-field facing region that is less disperse.

FIGS. 1 and 4 show that, in some applications, focusing a distribution of sound energy may provide insufficient spatial coverage of the desired regions.

In one arrangement of this disclosure, predicting the size of away from the focus is done by drawing an imaginary boundary through the edges of the transducer array, converging through the focus point. The volume generated may then be sectioned into various frusta. While each may be used to contain a volume through which acoustic energy flux is propagated, the requirement is for a suitable focusing position to be calculated given an uncertainty or interaction volume, which inverts the problem.

To achieve this then a series of abstract planes must be constructed which bound both the emitting transducer array and the volume of uncertainty or volume through which energy flux is to be conducted. By then equating defining equations for the properties of these geometric objects (the planes and the volume of the region of interaction) the position of the focus that generates a volume of projection that encapsulates the interaction or uncertainty volume can be created. For simplicity, a possible description of a region or uncertainty could be a sphere in three-dimensions or a circle in two-dimensions, although any geometric description of a region is permissible.

There are also two choices, a near-field side volume, where the focus is further from the array than the volume target and a far-field side volume, where the focus is closer to the array than the volume target. For illustrative purposes and without loss of generality, the following algebra describes a two-dimensional example wherein planes are replaced by lines and the potentially spherically shaped volume by the area of a circle and assumes that the system has been transformed such that the volume in front of the array progresses away from the transducer in increments of positive x. Three-dimensional cases may be reduced to this by taking cross sections of a system and transforming into this coordinate system. Given this transformation, the line solutions may be classified in terms of how fast they increase in x and this used to determine the near-field side and far-field side solutions.

In the two-dimensional case, there are two lines with parametric equations which bound the transducer array and the projected focusing volume:

x=t_{1,x}+λ₁(1),

y=t_{1,y}+λ₁(d_{1,y}),

and

x=t_{n,x}+λ₂(1),

y=t_{n,y}+λ₂(d_{2,y}),

as the gradient in x because it can be freely chosen to scale the system since it must increase.

The equation for a circle and thus the circular region that is described is:

(x−x₀)²+(y−y₀)²=r²,

Substituting the first line yields:

(t_{1,x}+λ₁(1)−x₀)²+(t_{1,y}+λ₁(d_{1,y})−y₀)²=r²,

t_{1,x}²−2t_{1,x}x₀+x₀²+λ₁²+2λ₁(t_{1,x}−x₀)+t_{1,y}²−2t_{1,y}y₀+y₀²+(λ₁d_{1,y})²+2λ₁d_{1,y}(t_{1,y}−y₀)−r²=0.

Needing to solve for λ₁ initially the quadratic formula is for the roots p_{±}:

$${p}_{\pm } = \frac{- b \pm \sqrt{{b}^{2} - 4 a c}}{2 a} ,$$

Where in this case:

a=1+d_{1,y}²,

b=2(d_{1,y}(t_{1,y}−y₀)+t_{1,x}−x₀),

c=t_{1,y}²−2t_{1,y}y₀+y₀²−r²,

For any given gradient there must be one solution when the line intersection is a tangent, so the discriminant of the quadratic solution for λ₁ must be zero, yielding:

b²−4ac=0,

4(d_{1,y}(t_{1,y}−y₀)+t_{1,x}−x₀)²−4(1+d_{1,y}²)(t_{1,y}²−2t_{1,y}y₀+y₀²−r²)=0,

which is again a quadratic in d_{1,y} the gradient of the line required. As the quadratic roots produced by the formula have the two choices of adding or subtracting a necessarily positive square root, and it is known that the far-field side solution involves a more positive d_{1,y} (that divides more the gradient factor 1/d_{1,y}), then it can be seen that the addition of the square root must describe the far-field side solution and the subtraction the near-field side solution.

By pursuing the same methodology for t_{n,x} and λ₂ solutions for the other line may be found. By matching near- and far-field side solutions (where both lines either use the positive or negative square root discriminant solutions) for each, the position of the control point for each solution may be found as the intersection of the two lines in each of the two cases as shown in FIGS. 2 and 5 for the near field side solutions and FIGS. 3 and 6 for the far field side solutions.

An alternative approach to finding cross-sections may also be used for the three-dimensional case. By taking the equation of a plane as:

x=t_{1,x}+μ₁(t_{1,x}−t_{n,x})+μ₂d_{1,x},

y=t_{1,y}+μ₁(t_{1,y}−t_{n,y})+μ₂d_{1,y},

z=t_{1,z}+μ₁(t_{1,z}−t_{n,z})+μ₂d_{1,z},

and using the constraint that the directions modulated by μ₁ and μ₂ are perpendicular, that is:

d_{1,x}(t_{1,x}−t_{n,x})+d_{1,y}(t_{1,y}−t_{n,y})+d_{1,z}(t_{1,z}−t_{n,z})=0,

and having transformed the system such that the focusing and region always occurs at positive x means that d_{1,x} may be set to unity. Taking the equation of a sphere:

(x−x₀)²+(y−y₀)²+(z−z₀)²=r²,

substituting the plane equations into this and finding the tangent solutions by setting the discriminant when considering the quadratics in μ₁ and μ₂ to zero yields more constraint equations. The three-dimensional case may then be solved similarly to the two-dimensional case, only that here three planes must be used to derive the final control point position.

Offset focusing may be changed depending on a smoothly evolving size or shape of the region required. In the case that this is due to uncertainty in location, this may reflect changing knowledge about probable error. This ensures that the smoothness of the element is preserved over time scales that could otherwise cause pops and clicks in the output.

This algorithm may also be extended to multiple arrays, but the inverse image will contain some of the distributions of the array footprints as it will beyond the focus form an inverted image of the contributing arrays. This may be undesirable but might remain serviceable if the redistribution of wave power is small.

In another arrangement, a gaussian optics approximation can be used to estimate the cross-sectional area (waist) of the focused acoustic field and then offset the as necessary to achieve a similar effect to the above method.

In gaussian optics the waist of a focused beam is given by:

$$w ( z ) = {w}_{0} \sqrt{1 + {( \frac{z}{{z}_{R}} )}^{2}} , \qquad ( 1 )$$

where w₀ is the radius of the beam at the focus and:

$${z}_{R} = \frac{π {w}_{0}^{2}}{λ} ,$$

is the so-called Rayleigh range and λ is the wavelength of the sound frequency being utilized. In these equations, z is the range from the focus along the direction of the wave vector. The w₀ used in equation 1 can be measured at a variety of locations and then referenced within a lookup table or estimated using:

$${w}_{0} = \frac{λ}{πθ} ,$$

where θ is the angle from the edge of the array to the focal point (in radians) relative to the wave vector direction. In this case of a predominately round array this will have a singular value. In the case of an irregularly shaped array (square, rectangular, elliptical, etc.) this value represents the waist along a plane formed by the focal point, the center of the array, and the edge point for which θ is derived. In practice, the effective radius along various planes could be individually evaluated and together used to find a solution or they could be combined to form a single combined radius at any particular point.

For this arrangement, after a desired focal radius at a given point relative to the array is selected, calculation of the focal point location proceeds as follows. First, a desired focus radius and location is selected from external factors (uncertainty, desired beam shape, etc.) Next, at least one w₀ is estimated at that location using pre-measured values or estimated using above equations. Next, equation 1 is solved for z for a desired w(z). This will give the offset from the focus z along the wave vector direction. To achieve the desired focus radius the new focus location is selected by adjusting the focus location long this direction by the z-offset amount. The change can be positive (moving the focus past the previous focus location) or negative (moving the focus ahead of the previous focus location). The choice of which direction to take is chosen by the user.

The above formulation applies when the z-offset derived is comparable to z_{R}. If the desired focus radius is significantly larger than w₀, z-offset will be large and then the optic approximation becomes less and less reliable. In that case, iterative solving can refine the solution. This involves first solving for the z-offset as above and deriving a new focus location. Next w₀ is evaluated at the new focus location using previous discussed methods and using equation 1, a focus radius can be determined at original focus point. If this evaluation of the focus radius is close enough to the desired solution (as specified by the user) then the algorithm is finished. If not, a new z-offset can be calculated using equation 1 and the new w₀. The new z-offset represents a refined offset from the original focus point. This new offset can be evaluated for accuracy with yet another w₀ (based upon the refined location), and so on. This guess-and-check iterative approach can converge on a solution.

The gaussian optic approximation uses a small-angle approximation and becomes less accurate as θ becomes large. Therefore, θ could serve as an evaluation parameter to select between different methods for offset calculation.

III. Conclusion

While the foregoing descriptions disclose specific values, any other specific values may be used to achieve similar results. Further, the various features of the foregoing embodiments may be selected and combined to produce numerous variations of improved haptic systems.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A method comprising:
establishing a transducer array having a plurality of ultrasonic transducers with known relative positions and orientations;
defining a control field having a known spatial relationship relative to the transducer array;
using update data portions, updating a time-of-flight for each of the plurality of ultrasonic transducers so that a signal emitted from each of the plurality of ultrasonic transducers arrives at the control field at approximately the same time;
wherein the updating comprises:
based on the nature of the update data portion, allocating the update data portion to a first channel or a second channel to communicate with each of the plurality of ultrasonic transducers;
wherein the first channel is used when the nature of the update data portion relates to the location of the control field; and
wherein the second channel is used when the nature of the updated data portion does not relate to the location of the control field.

2. The method as in claim 1, wherein communication using the first channel is faster than communication using the second channel.

3. The method as in claim 2 further comprising:
adding time data to the update data portion, wherein the time data is related to a future event for the control field.

4. The method as in claim 3, wherein the updated data portion relates to at least one of: instantaneous change of a transducer driving signal to a preloaded state, powering the transducer array, phase shifting at the control field, triggering an external device, and generating debugging information.

5. The method as in claim 2 further comprising:
adding time data to the update data portion, wherein the time data is related to a past event for the control field.

6. The method as in claim 5, wherein the updated data portion relates to at least one of: recording a test signal, component failure, and processing information through an input device.

7. The method as in claim 2, wherein communication from the first channel to each of the plurality of ultrasonic transducers occurs in a staggered fashion.

8. A method comprising:
establishing a transducer array having a plurality of ultrasonic transducers with known relative positions and orientations;
defining a control field having a known spatial relationship relative to the transducer array;
defining a point of interest in the control field;
defining a direction of energy flux at the point of interest as a wave vector;
calculating an acoustic pressure profile within the control field using a plane normal to the wave vector;
calculating a size of the acoustic pressure profile; and
adjusting parameters of the plurality of ultrasonic transducers to increase the size of the acoustic pressure profile.

9. The method as in claim 8, wherein the wave vector is derived through a solution to a wave equation for the control field.

10. The method as in claim 8, wherein the wave vector is derived through a weighted sum of wave vectors from the plurality of ultrasonic transducers.

11. The method as in claim 8, wherein the wave vector is derived from the direction between a focus point of the control field and the geometric center of the transducer array.

12. The method as in claim 8, wherein calculating the acoustic pressure profile includes generating a volume by determining the distance between a focus point of the control field and the geometric center of the transducer array using an imaginary boundary through edges of the transducer array converging through the focus point.

13. The method as in claim 12, further comprising:
sectioning the volume into frusta.

14. The method as in claim 13, further comprising:
constructing a series of abstract planes that bound the transducer array and the volume.

15. The method as in claim 14, wherein the volume is a near-field side volume that is closer to the transducer array than the focus point of the control field.

16. The method as in claim 14, wherein the volume is a far-field side volume that is farther to the transducer array than the focus point of the control field.

17. The method as in claim 14, wherein the focus point of the control field is located within the volume.

18. The method as in claim 8 calculating the acoustic pressure profile includes a gaussian optics approximation.

19. The method as in claim 18, wherein the gaussian optics approximation uses offset focusing.
